(19) United States
(12) Patent Application Publication
(10) Pub. No.: US 2009/0280043 A1
(43) Pub. Date: Nov. 12, 2009

(54) Activation device

(75) Inventor: Tobi W. Ferguson, Lutz, FL (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: James A. Donovan, Tarpon Springs, FL (US)

(21) Appl. No.: 12/152,013

(22) Filed: May 12, 2008

(51) Int. Cl. B01J 8/00

(52) U.S. Cl. 422/236

(57) ABSTRACT

A device for activating a two component reaction system where the two reaction component are in separate containers with one container inside the other. The containers are sealed from each other and the inner container includes an activation element for opening a part of the seal. A pressure differential between the pressure in the inner and outer containers is made so the inner container has the higher pressure. Opening a part of the seal in the inner container drives the second component to react with the first reaction component. The seal is opened by cutting the inner container.

### BACKGROUND

This invention relates to an activation device for activating a two component reaction system where the two reaction component are in separate containers with one container inside the other. An example of such a reaction system is a system for heaters of personal hygiene wipes or cloths used to cleanse various parts of the body. More particularly, the invention relates to an improved activation device package for a personal hygiene wipe or cloth that is temperature controlled to give increased comfort and utility.

Personal hygiene wipes are often used by persons when they are away from their home and do not have access to a shower or bath. They are also used when the part of the person that is to be cleaned is small, and a shower or bath consumes too much time.

In order to be effective, however, personal hygiene wipes need to be warmed or heating in order to more effectively clean the hands or other parts of the user's anatomy. At the present time, warm wipes are only attainable by the use of an external source of hot water, or by inserting the wipes into a microwave or other heating device. This presents a danger as the degree of heating may vary, and it is possible to have excessive heat applied to the skin.

A major drawback of the use of an exothermic reaction to generate heat upon demand is that the various components have to be kept totally separated from each other until they are combined, and when combined need to react quickly and over a reasonable surface area. If the reaction only takes place at one location, excessive heat will be generated. If the reaction components are spread out, there has not been any way to combine them from the dispersed locations to generate uniform exothermic reaction. The problem that occurs is that the heater gives too much heat to part of the object to be heated and too little to other parts.

Yet another drawback to chemical generation of heat is that the reaction depends on adequate mixing that does not happen quickly enough to be useful.

It would be a great advantage if a way of bringing a two component reaction system together to react in a quick and effective manner.

Another advantage would be to provide a way of bringing a two component reaction system together that is controlled and requires a specific action by the user such that the action is not one experienced by the system when carried about prior to use.

Yet another advantage would be to provide a way to activate a heater to generate heat by an exothermic reaction over a personal hygiene wipe sized area quickly, without having to wait for an activation agent to make its way to all the reaction components, and without.

Other advantages will appear hereinafter.

### SUMMARY

It has now been discovered that the above and other advantages of the present invention may be accomplished in the following manner. The unique aspect of this invention is the placement of one reaction component of a two component reaction system inside one container and the second reaction component inside a second container that is inside the first container. An actuation device is provided to open the inner container, such as by piercing it, so the reaction can be effectively activated in a simple manner.

In it's simplest form the invention comprises a two component activation device such as those used for a heater in a package holding personal hygiene wipes. Other two component reaction systems, such as, by way of example and not by way of limitation, are systems where the reaction absorbs heat or effectively provides a cooling effect. Another example of a two component system is one that keeps an adhesive such as an epoxy resin separate from the catalyst that causes it to react until the time for bonding something is at hand. Cosmetics, edible products, medicines and diet supplements are other examples of products that it may be desirable to mix quickly, particularly mixing a solid and a liquid.

By way of illustration of the use of the present invention, a heater system is described herein for generating warming heat over substantially all the heater's surface. In one example, a package having one or more personal hygiene wipes is placed against the heater system such that the access opening to remove one or more wipes faces away from the heater. In other embodiments the heater is in the package with the personal hygiene wipes.

The two component reaction system includes an inner container and an outer container, each of which have one of the reaction components. The device of this invention allows the activation of the reaction when the user decides the time has come to do so. There is, in the preferred embodiment, a pressure differential between the outer container at a lower pressure than the inner container so that the reaction agent is thrust out of the inner container into contact with the reaction component inside the outer container. The outer container may have an internal vacuum sufficient to pull the activation agent into the outer container upon opening said seal. Alternatively, the inner container may have a pressure above atmospheric pressure to accomplish the same rapid mixing.

### BRIEF DESCRIPTION OF THE DRAWINGS

FIG. 1 is a perspective view of the device of this invention.

FIG. 2 is a section view taken along line 2-2 of FIG. 1

FIGS. 3a and 3b are illustrations of one embodiment of this invention.

FIGS. 4a and 4b are illustrations of another embodiment of this invention.

FIGS. 5a and 5b are illustrations of another embodiment of this invention.

### DETAILED DESCRIPTION

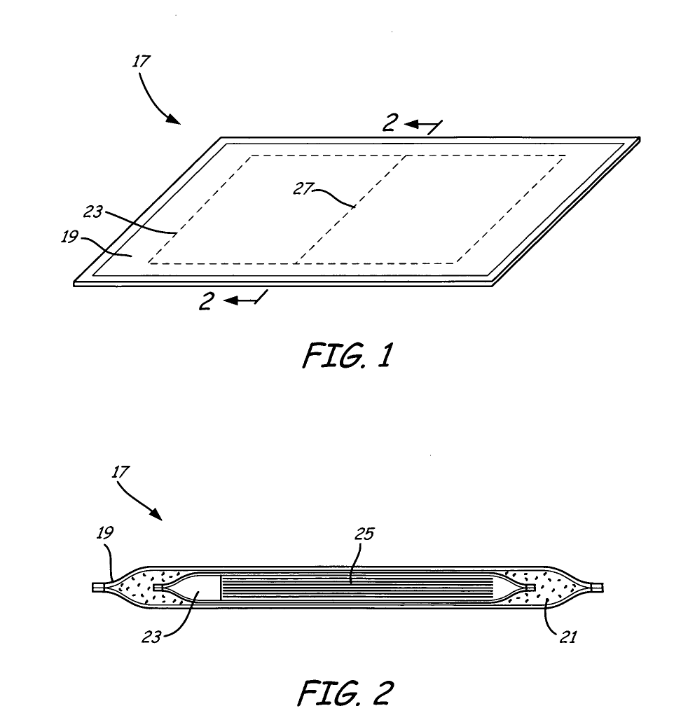

The device of this invention, 17 generally, is shown in FIG. 1 and includes an outer container 19 having a first reaction component therein. Also inside the outer container 19 is inner container 23 having a second reaction component therein. Part of the inner container 23 is an activation element 27, described in more detail below.

In order to have an uniform and even mixing of the two reaction components, it is preferred that the inside of inner pouch 23 be at atmospheric pressure or 14.7 psi, and the inside of the outer pouch 19 be under vacuum. Preferred pressures in outside pouch 19 are from about 8 psi to about 13 psi, with 10 or 11 psi being preferred. It is necessary to have a pressure differential between the inside of both pouches to be sufficient to pull the activating agent 25 to the entire area where the heat generating material 21 has been placed. Alternatively, the inner pouch can have an increased pressure of from about 17 to 22 psi, and preferably from about 19 to 20 psi. Too little or too great a pressure differential is not desired, for design and reliability reasons.

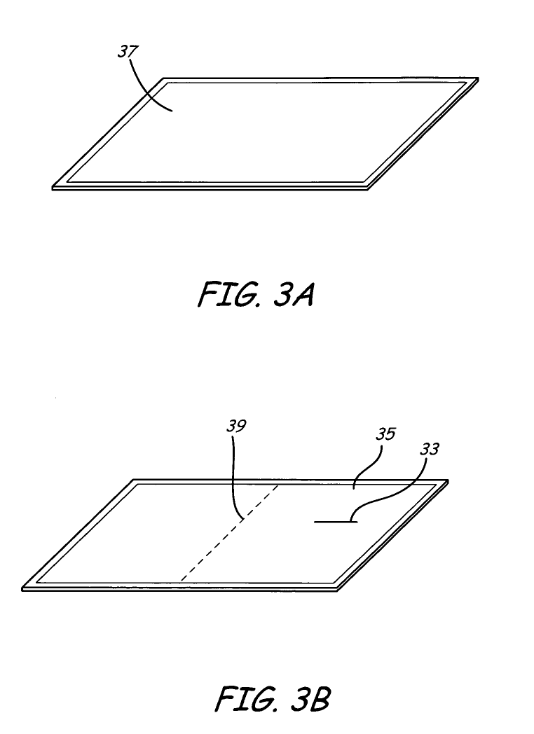

The activation element in FIGS. 3a and 3b is formed in inner container 35 that has a rigid side, 33, shown here, that has a score 39 cut in the rigid side. The other side, 37 is flexible. When container 35 is flexed or bent, score 39 ruptures and the contents in container 35 are driven into the outer container, such as outer container 11 of FIG. 1.

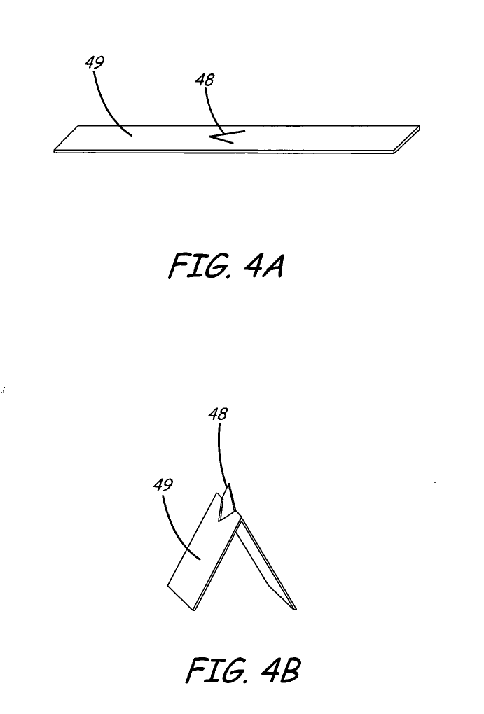

The activation element in FIGS. 4a and 4b are to be placed inside the inner container 23 of FIG. 1 or another container. The inner container is made from a flexible, pierceable material such as polyethylene or any of the conventional plastics. The activation element of FIGS. 4a and 4b is in the form of a strip 49 of relatively rigid plastic, although other materials can be used. Strip 49 has a triangle 48 cut into its surface and when the strip 45 is bent, triangle 48 protrudes and penetrates the wall of the inner container 23. The sharp end 48a of triangle 48 pierces the side of the inner container or pouch 23, and the pressure differential drives the contents to react.

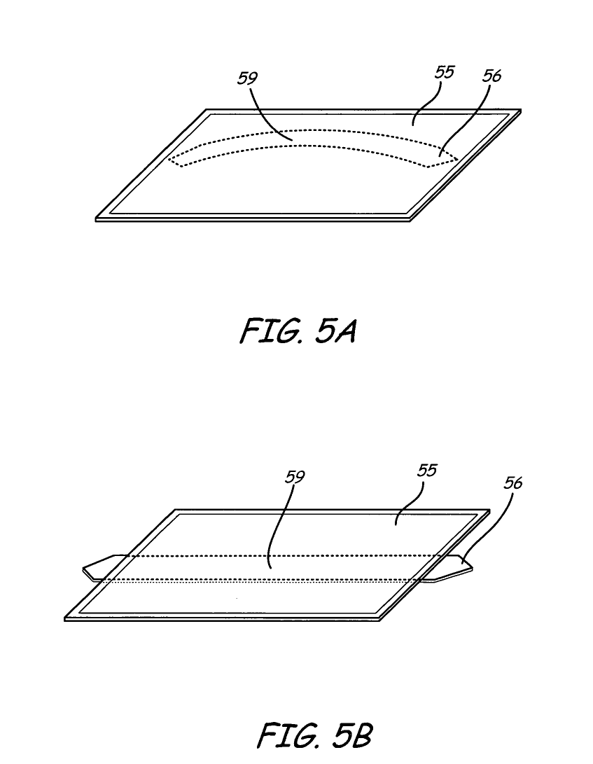

The activation element in FIGS. 5a and 5b is a semi-flexible strip 59 that is longer that inner container 55. Strip 59 is bent into a bowed shape so that it fits inside container 55 and has at least one sharp end 56 that punctures inner container 55 when the container 55 and strip 59 are flexed, thereby straightening strip 59 and puncturing the end of container 55.

There are a number of combinations of heat generating materials and activating agents that are suitable for use in the present invention. The selection of specific components is to be based upon cost, compatibility, ease of control of the exotherm, and other factors.

The preferred activating material of this invention is water. This is plentiful and safe, and reacts with a number of materials to produce an exothermic reaction.

The preferred heat generating material is a crystal that, when free from moisture, is stable for up to three to five years or more, and which react when moisture is present to generate heat. The preferred crystal is made from crystalline calcium oxide. Calcium oxide is commercially available from a number of sources, one of which being Calcium Oxide Fisher Scientific S79946. For efficient integration of this component into the fabric, the calcium oxide is ground into small particles or crystals and a sieve is used to insure uniform particle size.

In a series of tests of the preferred embodiment as described above using water to react with calcium oxide, 100% of the activations by bending the packages resulted in warm personal hygiene wipes. Then a similar set of packages were prepared, with the only change being no vacuum inside the outer pouch, only 30% of the wipes achieved the desired temperature.

It is also an embodiment of the present invention to employ a temperature changing chemical that causes a drop in temperature when contacted by water, creating an endothermic reaction. The solid materials may, for example, include materials such as sodium sulfate* 10H₂O; sodium bicarbonate, ammonium nitrate, ammonium chloride, urea, ammonium dichromate, citric acid, potassium perchlorate, potassium sulfate, potassium chloride, calcium nitrate, and vanillin. These solid compounds react with water in an endothermic fashion to impart cooling. Reactions can be with water based mixtures as well as other liquid systems. Other uses of the activation of a two component reaction system.

Although the present invention has been described with reference to preferred embodiments, workers skilled in the art will recognize that changes may be made in form and detail without departing from the spirit and scope of the invention.

1. A device for activating a two component reaction system, comprising:
a first container having a first reaction component therein;
a second container having a second reaction component therein, the second container being positioned inside the first container, the second container being sealed from the first container and having an activation element therein for opening a part of the sealed second container;
a pressure differential between the pressure in the second container and the first container such that the second container has a higher pressure that the first container, whereby, upon opening a part of the seal keeping the second reaction component in the inner pouch, the second component is driven into the outer pouch to react with the first reaction component.

2. The device of claim 1, wherein the pressure differential is caused by a vacuum inside the first container.

3. The device of claim 2, wherein the amount of vacuum in the first container is sufficient to give a pressure of from about 8 to 13 psi.

4. The device of claim 1, wherein the pressure differential is caused by an elevated pressure inside the second container.

5. The device of claim 1, wherein the second container is a pouch having a rigid side and a flexible side, and the activation element is a score cut into the rigid side that is adapted to rupture upon bending to open the second container to allow the second reaction component to enter the first container to react with the first reaction component.

6. The device of claim 1, wherein the second container is a pouch having a rigid element having at least one sharp part positioned to pierce the pouch upon bending the first container.

7. The device of claim 6, wherein the at least one sharp part of the rigid element is a triangle cut into the rigid element such that the triangle emerges from the rigid element when the rigid element is bent to cause the triangle to pierce a portion of the pouch.

8. The device of claim 6, wherein the rigid element is longer than the inside of the pouch and is bowed inside the pouch, and the at least one sharp part of the rigid element is on at least one end of the rigid element such that the at least one sharp part lengthens when the pouch is bent to pierce a portion of the pouch.

9. The device of claim 1, wherein the first container is a flexible pouch and the first reaction component is a heat generating material, and the second container is a flexible pouch and the second reaction component is an activation action for reacting with the heat generating material upon contact therewith.

10. The device of claim 9, wherein the actuation agent is water and the heat generating material is crystalline calcium oxide.

11. A method for activating a two component reaction system, comprising:
placing a first reaction component in a first container;
placing a second reaction component in a second container, the second container being positioned inside the first container and sealed from the first container, the second container having an activation element therein for opening a part of the sealed second container;
providing a pressure differential between the pressure in the second container and the first container such that the second container has a higher pressure than the first container, whereby, upon opening a part of the seal keeping the second reaction component in the inner pouch, the second reaction component is driven into the outer pouch to react with the first reaction component; and
bending the first container to cause the activation element to open a part of the second container to drive the second component to react with the first component.

12. The method of claim 11, wherein the pressure differential is caused by a vacuum inside the first container.

13. The method of claim 12, wherein the amount of vacuum in the first container is sufficient to give a pressure of from about 8 to 13 psi.

14. The method of claim 11, wherein the pressure differential is caused by an elevated pressure inside the second container.

15. The method of claim 11, wherein the second container is a pouch having a rigid side and a flexible side, and the activation element is a score cut into the rigid side that is adapted to rupture upon bending to open the second container to allow the second reaction component to enter the first container to react with the first reaction component.

16. The method of claim 11, wherein the second container is a pouch and the activation element has at least one sharp part positioned to pierce the pouch upon bending the first container.

17. The method of claim 16, wherein the at least one sharp part of the activation element is a triangle cut into the activation element such that the triangle emerges from the activation element when the activation element is bent to cause the triangle to pierce a portion of the pouch.

18. The method of claim 16, wherein the activation element is longer than the inside of the pouch and is bowed inside the pouch, and the at least one sharp part of the activation element is on at least one end of the activation element such that the at least one sharp part lengthens when the pouch is bent to pierce a portion of the pouch.

19. The method of claim 11, wherein the first container is a flexible pouch and the first reaction component is a heat generating material, and the second container is a flexible pouch and the second reaction component is an activation agent for reacting with the heat generating material upon contact therewith.

20. The method of claim 19, wherein the actuation agent is water and the heat generating material is crystalline calcium oxide.
